(19) United States
(12) Patent Application Publication
(10) Pub. No.: US 2014/0115308 A1
(43) Pub. Date: Apr. 24, 2014

(54) CONTROL METHOD, CONTROL DEVICE AND COMPUTER SYSTEM

(71) Applicants: LENOVO (BEIJING) CO., LTD., Beijing (CN); BEIJING LENOVO SOFTWARE LTD., Beijing (CN)

(72) Inventors: Fanzhi Li, Beijing (CN); Xuguo Liu, Beijing (CN); Daming Wu, Beijing (CN); Lingjun Xu, Beijing (CN); Xianqun Yi, Beijing (CN); Liangyin Yang, Beijing (CN)

(73) Assignees: BEIJING LENOVO SOFTWARE LTD., Beijing (CN); LENOVO (BEIJING) CO., LTD., Beijing (CN)

(21) Appl. No.: 14/122,649

(22) PCT Filed: May 30, 2012
(86) PCT No.: PCT/CN2012/076266

§ 371 Date: Nov. 26, 2013

(30) Foreign Application Priority Data
May 30, 2011 (CN) 201110142364.X
Jun. 20, 2011 (CN) 201110166631.7

(51) Int. Cl. G06F 9/44; G06F 9/48

(52) U.S. Cl. CPC G06F 9/4406; G06F 9/48
USPC 713/1

(57) ABSTRACT

A control method and a control device applied in a computer system, and a computer system are described. The control method according to the embodiments of the present invention is applied in a computer system, wherein the computer system includes a system memory containing two divided storage areas with the two storage areas being respectively a first storage area and a second storage area. The control method includes loading a first operating system into the first storage area; running the first operating system; and starting up a system memory access drive by the first operating system, so as to load into the second storage area the pre-stored memory mapping data of the second operating system by the system memory access drive.

### CROSS REFERENCE TO RELATED APPLICATIONS

This application is a national phase application based on international application number PCT/CN2012/076266, filed May 30, 2012, and claims priority of Chinese Patent Application No. CN 201110142364.X, filed on May 30, 2011, and Chinese Patent Application No. CN 201110166631.7, filed on Jun. 20, 2011, the contents of which are incorporated by reference herein in their entireties.

### TECHNICAL FIELD

The present application relates to a control method and a control device applied in a computer and a computer system. Particularly, the present application relates to a computer system with two operating systems, a control device applied in the computer system and the corresponding control method.

### BACKGROUND

With the development of the technology, the computing devices such as a personal computer, a portable computer, a tablet computer, or the like are widely used, and the user's demands on the computer device are experiencing a diversified development. For example, when the data processing is performed frequently, it is desired that the computer is of a powerful processing capacity to perform a high-speed calculation. On the other hand, when there is no need to operate frequently, and it is desired that the computer can perform a long time standby, thus the computer is needed to operate in an energy-saving way.

To satisfy the different demands of the user, there is proposed a computer with two operating systems, which have different characteristics. For example, one operating system may be the Window®7 operating system with a relative powerful processing capacity, while the other operating system may be the Android® operating system with a relative weak processing capacity that needs less resource and power consumption. However, when the computer performs a switching between the two operating systems, since it is needed to put the current running operating system in a sleep state, load the system files of the second operating system from the memory into the system memory, and then run the second operating system. That is, the currently running operating system should first save the field, for example, it stores the data of the currently running applications into the memory of the computer, and then starts up the other operating system and restores the applications that were stored into the memory manually by the user in the other operating system. In turn, this results in a long time taken for the switching between the two operating systems, a tedious operation, and the processing performed on different partitions on the hard disk.

### SUMMARY

Embodiments of the present application are directed to provide a computer system with two operating systems, a control device applied in the computer system and a corresponding control method to overcome the foregoing problems.

One embodiment of the present application provides a control method applied in a computer system, wherein the computer system includes a system memory, which is divided into two storage areas, the two storage areas being a first storage area and a second storage area. The control method comprises loading a first operating system into the first storage area; running the first operating system; and launching a system memory access drive by the first operating system to load the pre-stored memory image data of a second operating system into the second storage area by the system memory access drive.

Another embodiment of the present application provides a control device applied in a computer system, wherein the computer system includes a system memory, which is divided into two storage areas, the two storage areas being a first storage area and a second storage area. The control device comprise a system loading unit configured to load a first operating system into the first storage area; a system running unit configured to run the first operating system; and a image data loading unit having a system memory access drive configured to launch the system memory access drive by the first operating system so as to load the pre-stored memory image data of a second operating system into the second storage area through the system memory access drive.

Another embodiment of the present application provides a computer system comprises a system memory having a first storage area and a second storage area; an image data storage unit configured to store the memory image data; a Basic Input/Output System including a system loading module configured to load the first operating system into the first storage area; and a processing unit including a system running module configured to run the first operating system, and an image data loading module having a system memory access drive configured to launch the system memory access drive by the first operating system so as to load the pre-stored memory image data of a second operating system into the second storage area through the system memory access drive.

Through the solution provided in the embodiments of the present application, the computer is enabled to switch between two operating systems effectively, and the time the switching of operating systems will be significantly saved. In addition, in the embodiments of the present application since there is no need to perform the installation of the second operating system and the normal booting process of the second operating system is omitted, thus the complexity relating to the installation and/or updating process of the second operating system is simplified.

On the other hand, an embodiment of the present application provides a control method applied in a computer, wherein the computer comprises a system memory which is divided into two storage areas, the two storage areas are a first storage area and a second storage area, the first storage area includes a first system storage portion and a first shared data storage portion, the second storage area includes a second system storage portion and a second shared data storage portion, and the first shared data storage portion and the second shared data storage portion overlap each other, the control method comprise loading a first operating system into the system memory; storing a first shared data into a first shared data storage portion and storing a first system data of the first operating system into a first system storage portion by the first operating system; loading a second operating system into a second system storage portion according to a second system switching instruction; and acquiring the first shared data from a second shared data storage portion by the second operating system, and performing the corresponding restoring operation according to the first shared data.

Another embodiment of the present application provides a control device applied in a computer, wherein the computer comprises a system memory which is divided into two storage areas, the two storage areas are a first storage area and a second storage area, the first storage area includes a first system storage portion and a first shared data storage portion, the second storage area includes a second system storage portion and a second shared data storage portion, and the first shared data storage portion and the second shared data storage portion overlap each other, the control device comprise a first loading unit configured to load a first operating system into the system memory; a first control unit configured to store a first shared data into the first shared data storage portion and store a first system data of the first operating system into the first system storage portion by the first operating system; a second loading unit configured to load a second operating system into the second system storage portion according to a second system switching instruction; and a second restoring unit configured to acquire the first shared data from a second shared data storage portion by the second operating system, and perform the corresponding restoring operation according to the first shared data.

Another embodiment of the present application provides a computer, comprises a system memory includes a first storage area having a first system storage portion and a first shared data storage portion, a second storage area having a second system storage portion and a second shared data storage portion, wherein the first shared data storage portion and the second shared data storage portion overlap each other; a processing unit includes a first loading unit configured to load a first operating system into the system memory; a first control unit configured to store a first shared data into the first shared data storage portion and store a first system data of the first operating system into the first system storage portion by the first operating system; a second loading unit configured to load a second operating system into the second system storage portion according to a second system switching instruction; and a second restoring unit configured to acquire the first shared data from a second shared data storage portion by the second operating system, and perform the corresponding restoring operation according to the first shared data.

Through the solution provided in the embodiments of the present application, the computer is enabled to switch between two operating systems to improve the utilization ratio of the system memory. In addition, by storing the data shared between the two operating systems into the overlapped portion of the two storage areas contained in the memory, even if a system switching has been performed, the shared data can be conveniently acquired in the switched operating system, so that the data synchronization between the two operating systems is achieved.

### BRIEF DESCRIPTION OF THE DRAWINGS

To illustrate the technical solutions of the embodiments of the present application, the accompanying drawings referenced to in the descriptions of the embodiments are described briefly. The accompanying drawings in the following descriptions are merely exemplary.

FIG. 1 depicts a flowchart of the control method according to an embodiment of the present application.

FIG. 2 depicts a flowchart of the control method according to another embodiment of the present application.

FIG. 3 depicts a flowchart of the control method according to another embodiment of the present application.

FIG. 4 shows an exemplary structure block diagram of the control device according to an embodiment of the present application.

FIG. 5 shows an exemplary structure block diagram of the control device according to another embodiment of the present application.

FIG. 6 shows an exemplary structure block diagram of the computer according to an embodiment of the present application.

FIG. 7 shows an exemplary structure block diagram of the computer according to an embodiment of the present application.

FIG. 8 shows an exemplary explanatory diagram of the system memory of the computer according to an embodiment of the present application.

FIG. 9 depicts a flowchart of the control method according to an embodiment of the present application.

FIG. 10 shows an exemplary structure block diagram of the control device according to an embodiment of the present application.

FIG. 11 shows an exemplary structure block diagram of the control device according to another embodiment of the present application.

FIG. 12 shows an exemplary structure block diagram of the computer according to an embodiment of the present application.

### DETAILED DESCRIPTION

The preferred embodiments of the present application will be described as follows with reference to the accompanying drawings. Please note that, in the description and the accompanying drawings, elements with the same or the similar structure and function will be designated by the same reference numbers and the repetitive explanation for these elements will be omitted.

In the following embodiments of the present application, the specific form of the computer system includes but not limited to a personal computer, a portable computer, a tablet computer, a smart phone, a personal digital assistant (PDA) or the like.

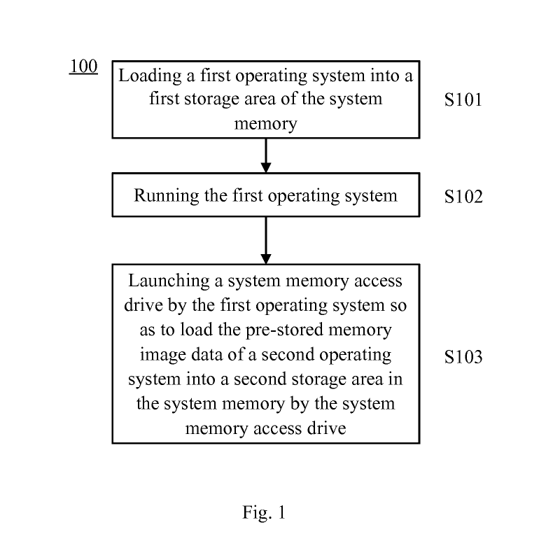

FIG. 1 depicts a flowchart of the control method according to an embodiment of the present application. In the following, FIG. 1 will depict the control method according to an embodiment of the present application.

The control method 10 shown in FIG. 1 can be applied in a computer system. The computer system includes a system memory, which is divided into a first storage area and a second storage area. As shown in FIG. 1, in step S101, a system memory of a first operating system is loaded into the first storage area of the system memory. Then, in step S102, the first operating system starts to run. In accordance to an example of the present application, the first operating system is loaded into the first storage area of the system memory via the Basic Input/Output System (BIOS), and the central processing unit (CPU) runs the first operating system after the loading thereof.

When the loading of the first operating system is completed and the first operating system starts to run, in step S103, a system memory access drive is launched by the first operating system to load the pre-stored memory image data into the second storage area in the system memory by the system memory access drive. The system memory access drive can directly access the physical address of the system memory. According to an example of the present application, during the running of the first operating system, CPU can launch the system memory access drive according to the instruction of the first operating system to load the pre-stored memory image data into the second storage area in the system memory by the system memory access drive. The memory image data of the second operating system can be loaded immediately after the loading of the first operating system is completed and the first operating system starts to run. Alternatively, the memory image data of the second operating system can be loaded at any time after the first operating system starts to run. When the first operating system starts to run, it can respond to the user's operation. The step of launching the system memory access drive by the first operating system to load the pre-stored memory image data into the second storage area in the system memory by the system memory access drive can be synchronous with responding to the user's operation without any interference there between. Responding to the user's operation is in the foreground, and loading the memory image data of the second operating system through the system memory access drive launched by the first operating system is in the background.

According to an example of the present application, the second storage area is invisible to the first operating system before launching the system memory access drive. For instance, in step S101, when the first operating system is loaded into the first storage area of the system memory by BIOS, BIOS can inform the first operating system that the range of physical addresses of the system memory is the range of physical addresses of the first storage area, so that the first operating system can only access the system memory of the first storage area without launching the system memory access drive. The system memory access drive can be configured to operate the system memory of the specified addresses directly and bypass the default memory control mechanics of the system. For example, the range of physical addresses of the second storage area can be stored in the system memory access drive, so that when the system memory access drive determines that it is invoked by the first operating system, the system memory access drive can operate the second storage area by the system memory access drive. Alternatively, when it is invoked by the first operating system, the system memory access drive can acquire the range of physical addresses of the second storage area. Thereby, by means of launching the system memory access drive by the first operating system, the pre-stored memory image data of the second operating system can be loaded into the second storage area in the system memory by the system memory access drive.

According to an example of the present application, it is possible to run the second operating system in advance, and during the running of the second operating system, the memory data used by the second operating system in the system memory at the current moment are acquired, and the memory data used by the second operating system in the system memory at the current moment acquired are stored in the storage unit (such as a hard disk) of the computer as the memory image data of the second operating system.

Through the control method of the present embodiment, it is possible to load the memory image data of the second operating system during the running of the first operating system, so that the second operating system can be restored directly through the memory image data, thus the time taken for the switching of operating systems will be significantly saved. Besides, since the second operating system is restored through the memory image data, there is no need to perform the installation of the second operating system, and the normal booting process of the second operating system is omitted, thus the complexity relating to the installation and/or updating process of the second operating system is simplified.

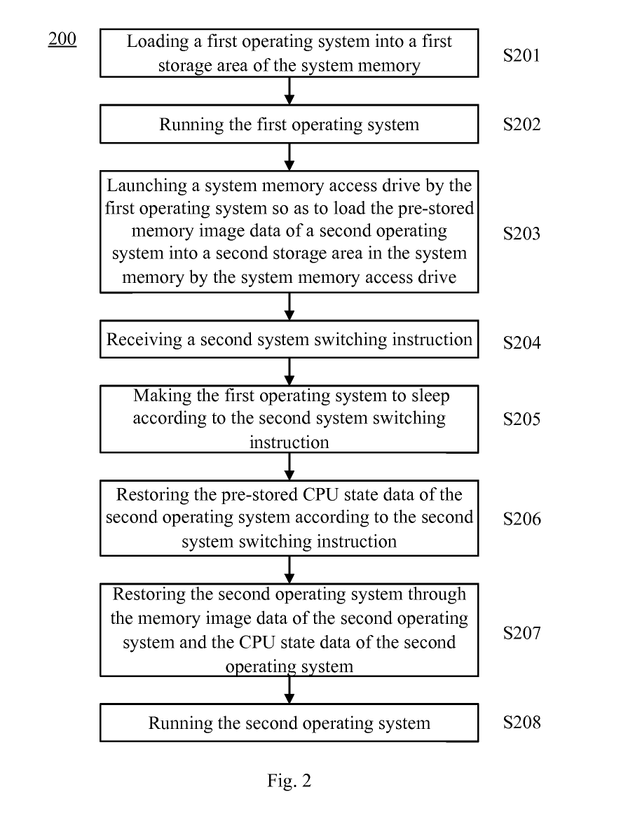

FIG. 2 depicts a flowchart of the control method 200 according to another embodiment of the present application. In the following, FIG. 2 will depict the control method according to another embodiment of the present application. In the embodiment, the control method 200 can be applied in the computer with the system memory divided into two storage areas. Specifically, the two storage areas of the system memory are a first storage area and a second storage area respectively.

As shown in FIG. 2, step S201 to step S203 in the control method 200 are similar with step S101 to step S103 in the control method 100 shown in FIG. 1. In step S201, a system memory of a first operating system is loaded into the first storage area of the system memory. Then, in step S202, the first operating system starts to run. When the loading of the first operating system is completed and the first operating system starts to run, in step S203, a system memory access drive is launched by the first operating system to load the pre-stored memory image data into the second storage area in the system memory by the system memory access drive.

As above, according to an example of the present application, it is possible to run the second operating system in advance, and during the running of the second operating system, the memory data used by the second operating system in the system memory at the current moment are acquired, and the memory data used by the second operating system in the system memory at the current moment acquired are stored in the storage unit (such as a hard disk) of the computer as the memory image data of the second operating system.

In addition, the control method 200 further comprises, as shown in FIG. 2, in step S204, receiving a second system switching instruction. According to an example of the present application, the user can input the second system switching instruction as needed. Alternatively, according to another example of the present application, in case that the computer system is a portable computer, it is possible to set a first state for running the first operating system and a second state for running the second operating system for the portable computer in advance, and the second system switching instruction is automatically generated by the computer system when it is detected that the portable computer is transformed to the second state from the first state, and the second system switching instruction is received by the corresponding component in the computer system. For example, when the portable computer is transformed from the state wherein the physical keyboard is normally used to the state of a tablet computer which does not use the physical keyboard (such as by rotating or turning over the screen), the second system switching instruction can be generated.

In step S205, the first operating system is put to sleep, according to the second system switching instruction. Then, in step S206, the pre-stored CPU state data of the second operating system is restored according to the second system switching instruction. According to an example of the present application, when the second system switching instruction is received, it is possible to make the first operating system to sleep by BIOS and restore the pre-stored CPU state data of the second operating system.

According to an example of the present application, it is possible to run the second operating system in advance, and during the running of the second operating system, the CPU state data at the current moment is also acquired at the time of acquiring the memory data used by the second operating system in the system memory and the CPU state data are stored into for example ROM-BIOS so as to restore the pre-stored CPU state data of the second operating system by BIOS. That is, in the embodiment, the pre-stored CPU state data of the second operating system and the pre-stored memory image data of the second operating system are acquired at the same time. Alternatively, it is also possible to store the CPU state data of the second operating system into other non-volatile memory.

In step S207, restoring the second operating system through the memory image data of the second operating system and the CPU state data of the second operating system. Then, in step S208, running the second operating system. According to an example of the present application, the second operating system is restored by BIOS according to the memory image data of the second operating system and the CPU state data of the second operating system, and the second operating system is run by the central processing unit (CPU) after restoring the second operating system. For example, when the second operating system is restored by BIOS in step S207, BIOS can inform the second operating system that the range of physical addresses of the system memory is the range of physical addresses of the second storage area, so that the second operating system can only access the system memory of the second storage area.

Through the control method of the present embodiment, it is possible to load the memory image data of the second operating system during the running of the first operating system, and when a switching between two operating systems is performed, it is possible to restore the second operating system by loading the pre-stored memory image data of the second operating system and the pre-stored CPU state data of the second operating system so that the time taken for the switching of operating systems will be significantly saved. Besides, since the second operating system is restored through the memory image data, there is no need to perform the installation of the second operating system, and the normal booting process of the second operating system is omitted, thus the complexity relating to the installation and/or updating process of the second operating system is simplified.

According to another example of the present application, when the second system switching instruction is received, the CPU state data of the first operating system is stored according to the second system switching instruction, and the CPU state data of the first operating system can be stored into the non-volatile memory such as ROM-BIOS in a similar way as that of the CPU state data of the second operating system. Besides, since the system memory does not power off, the system memory will maintain the memory data of the first operating system in the first storage area when receiving the second operating system switching instruction. Thus, during the running of the second operating system, when receiving the first operating system switching instruction, it is possible to switch to the first operating system from the second operating system quickly.

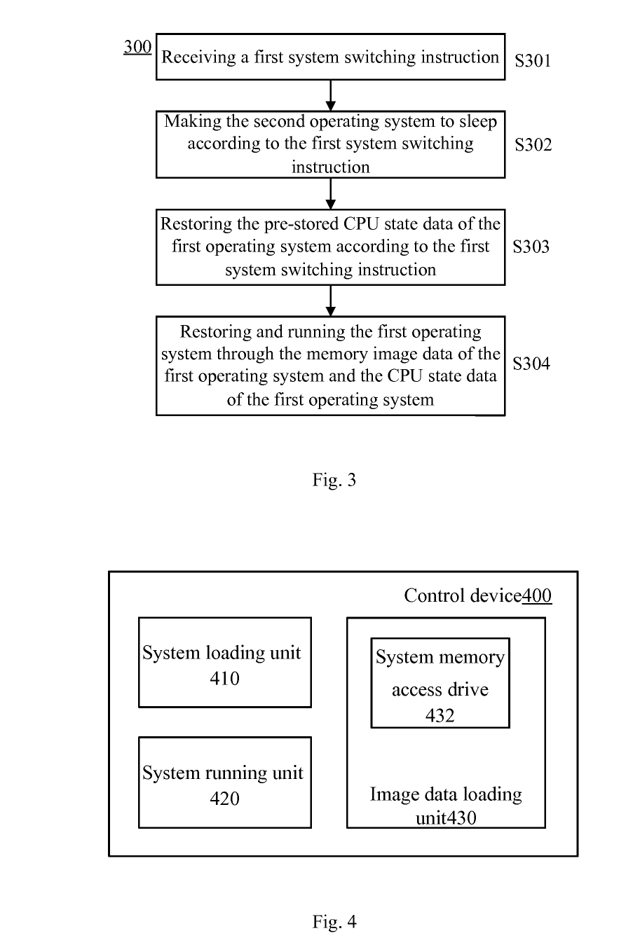

The control method of switching from the second operating system to the first operating system will be described in detailed with reference to FIG. 3. FIG. 3 shows the flowchart of control method 300 relating to switching from the second operating system to the first operating system during the running of the second operating system, when receiving the first operating system switching instruction after switching from the first operating system to the second operating system.

As shown in FIG. 3, in step S301, receiving a first system switching instruction. According to an example of the present application, the user can input the second system switching instruction as needed. Alternatively, according to another example of the present application, in case that the computer system is a portable computer, it is possible to set a first state for running the first operating system and a second state for running the second operating system for the portable computer in advance, and the second system switching instruction is automatically generated by the computer system when it is detected that the portable computer is transformed to the second state from the first state, and the second system switching instruction is received by the corresponding component in the computer system. For example, when the portable computer is transformed from the state wherein the physical keyboard is normally used to the state of a tablet computer which does not use the physical keyboard (such as by rotating or turning over the screen), the second system switching instruction can be generated.

In step S302, making the second operating system to sleep according to the first system switching instruction. Then, in step S303, restoring the pre-stored CPU state data of the first operating system according to the first system switching instruction. According to an example of the present application, when the first system switching instruction is received, it is possible to make the second operating system to sleep by BIOS and restore the pre-stored CPU state data of the first operating system. As above, the CPU state data of the first operating system was stored according to the second system switching instruction in the case of receiving the second system switching instruction during the running of the first operating system.

In step S304, restoring and running the first operating system through the memory image data of the first operating system and the CPU state data of the first operating system. According to an example of the present application, the first operating system is restored through the memory image data of the first operating system and the CPU state data of the first operating system maintained in the first storage area by the BIOS upon receiving the second operating system switching instruction, and the first operating system is run by the central processing unit (CPU) after restoring the first operating system. As above, the second storage area is invisible to the first operating system without launching the system memory access drive. For example, when the first operating system is restored by BIOS in step S304, BIOS can inform the first operating system that the range of physical addresses of the system memory is the range of physical addresses of the first storage area, so that the first operating system can only access the system memory of the first storage area.

The control method 300 can be performed after the control method 200 as shown in FIG. 2. Through the control method of the present embodiment, it is possible to restore and switch to the first operating system by the memory data maintained in the first storage area of the system memory upon receiving the second switching instruction and the CPU state data of the first operating system stored upon receiving the second switching instruction, so that the time taken for the switching between operating systems will be significantly saved.

According to another example of the present application, when the first system switching instruction is received, the CPU state data of the second operating system is stored according to the first system switching instruction. As above, the CPU state data of the second operating system can be stored into the non-volatile memory such as ROM-BIOS. Besides, since the system memory does not power off, the system memory will maintain the memory data of the second operating system in the second storage area when receiving the first operating system switching instruction.

When the memory data of the second operating system is maintained in the second storage area and the second system switching instruction is received during the running of the first operating system, it is possible to restore and run the second operating system through the memory data of the second operating system and the CPU state data of the memory data of the second operating system without need to load the image data of the second operating system into the second storage area of the system memory.

According to another example of the present application, after switching from the second operating system to the first operating system, the method shown in FIG. 3 further comprises receiving a power-off instruction during the running of the first operating system. Furthermore, the pre-stored memory image data of the second operating system is updated according to the memory data of the second operating system maintained in the second storage area so that the second operating system can run in the updated state for the next operation.

Next, the control device according to an embodiment of the present application is illustrated with reference to FIG. 4. FIG. 4 shows an exemplary structure block diagram of the control device 400 according to an embodiment of the present application. In the embodiment, the control device 400 can be applied in the computer with the system memory divided into two storage areas. Specifically, the two storage areas of the system memory are a first storage area and a second storage area respectively.

As shown in FIG. 4, the control device 400 of the present embodiment can comprise a system loading unit 410, a system running unit 420 and an image data loading unit 430. The units of the control device 400 can perform the steps/functions of the control method shown in FIG. 1. Thus, the detailed description is omitted for concision.

For example, the system loading unit 410 can load the first operating system into the first storage area. Specifically, the system loading unit 410 can load the first operating system into the first storage area when the computer system starts up. The system running unit 420 can run the first operating system.

The image data loading unit 430 can include a system memory access drive 432. When the loading of the first operating system is completed and the first operating system starts to run, the image data loading unit 430 can launch the system memory access drive by the first operating system to load the pre-stored memory image data into the second storage area in the system memory through the system memory access drive. The memory image data of the second operating system can be loaded by the image data loading unit 430 immediately after the loading of the first operating system is completed and the first operating system starts to run. Alternatively, the memory image data of the second operating system can be loaded by the image data loading unit 430 at any time after the first operating system starts to run.

According to an example of the present application, the second storage area is invisible to the first operating system without launching the system memory access drive. when the first operating system is loaded into the first storage area of the system memory by the system loading unit 410, the system loading unit 410 can inform the first operating system that the range of physical addresses of the system memory is the range of physical addresses of the first storage area, so that the first operating system can only access the system memory of the first storage area without launching the system memory access drive. The system memory access drive can be configured to operate the system memory of the specified addresses directly and bypass the default memory control mechanics of the system. For example, the range of physical addresses of the second storage area can be stored in the system memory access drive, so that when the system memory access drive determines that it is invoked by the first operating system, the system memory access drive can operate the second storage area by the system memory access drive. Alternatively, when it is invoked by the first operating system, the system memory access drive can acquire the range of physical addresses of the second storage area from BIOS. Thereby, by means of launching the system memory access drive by the first operating system, the pre-stored memory image data of the second operating system can be loaded into the second storage area in the system memory by the system memory access drive.

According to an example of the present application, it is possible to run the second operating system in advance, and during the running of the second operating system, the memory data used by the second operating system in the system memory at the current moment are acquired, and the memory data used by the second operating system in the system memory at the current moment acquired are stored in the storage unit (such as a hard disk) of the computer as the memory image data of the second operating system.

Through the control device of the present embodiment, it is possible to load the memory image data of the second operating system during the running of the first operating system, so that the second operating system can be restored directly through the memory image data, thus the time taken for the switching of operating systems will be significantly saved. Besides, since the second operating system is restored through the memory image data, there is no need to perform the installation of the second operating system, and the normal booting process of the second operating system is omitted, thus the complexity relating to the installation and/or updating process of the second operating system is simplified.

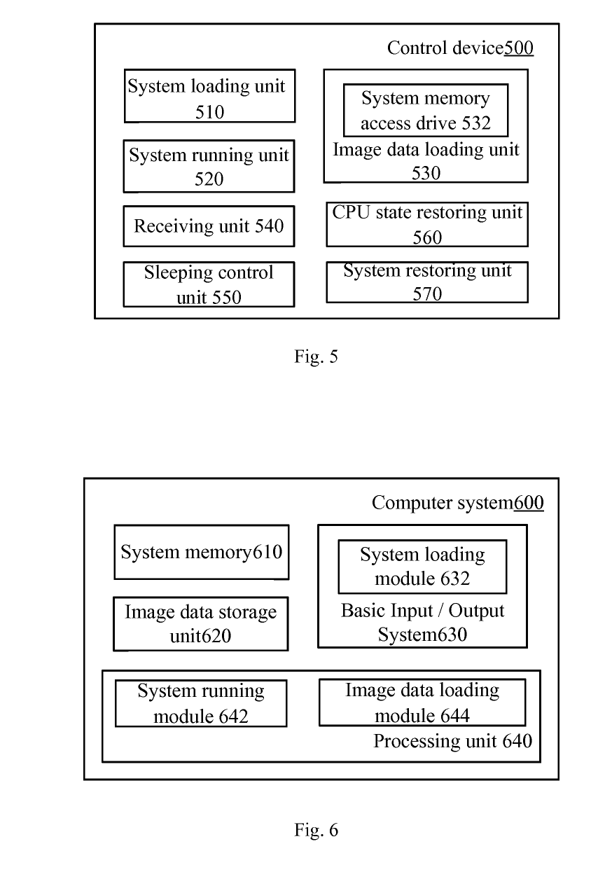

Next, the control device according to another embodiment of the present application is illustrated with reference to FIG. 5. FIG. 5 shows an exemplary structure block diagram of the control device 500 according to another embodiment of the present application. In the embodiment, the control device 500 can be applied in the computer with the system memory divided into two storage areas. Specifically, the two storage areas of the system memory are a first storage area and a second storage area respectively. The units of the control device 500 can perform the steps/functions of the control method shown in FIG. 2. Thus, the detailed description is omitted for concision.

For example, as shown in FIG. 4, which is similar with the control device 400 shown in FIG. 4, the control device 500 comprises a system loading unit 510, a system running unit 520 and an image data loading unit 530. The system loading unit 510 can load the first operating system into the first storage area. The system running unit 520 can run the first operating system. The image data loading unit 530 can include a system memory access drive 532. When the loading of the first operating system is completed and the first operating system starts to run, the image data loading unit 530 can launch the system memory access drive by the first operating system to load the pre-stored memory image data into the second storage area in the system memory through the system memory access drive. The memory image data of the second operating system can be loaded by the image data loading unit 530 immediately after the loading of the first operating system is completed and the first operating system starts to run. Alternatively, the memory image data of the second operating system can be loaded by the image data loading unit 530 at any time after the first operating system starts to run.

In addition, the control device 500 further comprises a receiving unit 540, a sleeping control unit 550, a CPU state restoring unit 560, and a system restoring unit 570. The receiving unit 540 can receive a second system switching instruction. According to an example of the present application, the receiving unit 540 can receive the second system switching instruction input by the user as needed. Alternatively, according to another example of the present application, in case that the computer system is a portable computer, it is possible to set a first state for running the first operating system and a second state for running the second operating system for the portable computer in advance, and the second system switching instruction is automatically generated by the computer system when it is detected that the portable computer is transformed to the second state from the first state, and the second system switching instruction is received by the receiving unit 540. For example, when the portable computer is transformed from the state wherein the physical keyboard is normally used to the state of a tablet computer which does not use the physical keyboard (such as by rotating or turning over the screen), the second system switching instruction can be generated and received by the receiving unit 540.

The sleeping control unit 550 can make the first operating system to sleep according to the second system switching instruction. Then, the pre-stored CPU state data of the second operating system can be restored by the CPU state restoring unit 560 according to the second system switching instruction.

According to an example of the present application, it is possible to run the second operating system in advance, and during the running of the second operating system, the CPU state data at the current moment is also acquired at the time of acquiring the memory data used by the second operating system in the system memory and the CPU state data are stored into for example ROM-BIOS so as to restore the pre-stored CPU state data of the second operating system by BIOS. That is, in the embodiment, the pre-stored CPU state data of the second operating system and the pre-stored memory image data of the second operating system are acquired at the same time. Alternatively, it is also possible to store the CPU state data of the second operating system into other non-volatile memory.

The system restoring unit 570 can be configured to restore the second operating system through the memory image data of the second operating system and the CPU state data of the second operating system. In the embodiment, the system running unit 520 can run the second operating system. According to an example of the present application, the second operating system is restored by BIOS according to the memory image data of the second operating system and the CPU state data of the second operating system, and the second operating system is run by the central processing unit (CPU) after restoring the second operating system.

According to another example of the present application, the first storage area in the system memory is invisible to the second operating system. For example, when the second operating system is restored by the system restoring unit 570, the system restoring unit 570 can inform the second operating system that the range of physical addresses of the system memory is the range of physical addresses of the second storage area, so that the second operating system can only access the system memory of the second storage area.

Though the description is made about the control device 500, which consists of the individual units, however, the present application is not limited to it. For example, the system loading unit, the sleeping control unit, the CPU state restoring unit, and the system restoring unit can be combined to form the Basic Input/Output System (BIOS), and the system running unit and the image data loading unit can be combined to form the central processing unit (CPU).

Through the control method of the present embodiment, it is possible to load the memory image data of the second operating system during the running of the first operating system, and when a switching between two operating systems is performed, it is possible to restore the second operating system by loading the pre-stored memory image data of the second operating system and the pre-stored CPU state data of the second operating system so that the time taken for the switching of operating systems will be significantly saved. Besides, since the second operating system is restored through the memory image data, there is no need to perform the installation of the second operating system, and the normal booting process of the second operating system is omitted, thus the complexity relating to the installation and/or updating process of the second operating system is simplified.

According to another example of the present application, the control device in FIG. 5 further comprises a CPU state storage unit. When the second system switching instruction is received by the receiving unit, the CPU state data of the first operating system is stored by the CPU state storage unit according to the second system switching instruction, and the CPU state data of the first operating system can be stored into the non-volatile memory such as ROM-BIOS in a similar way as that of the CPU state data of the second operating system. Besides, since the system memory does not power off, the system memory will maintain the memory data of the first operating system in the first storage area when receiving the second operating system switching instruction. Thus, during the running of the second operating system, when receiving the first operating system switching instruction, it is possible to switch to the first operating system from the second operating system quickly.

Next, the control device for switching from the second operating system to the first operating system is described in detail. The units of the control device 500 can perform the steps/functions of the control method shown in above figures. Thus, the detailed description is omitted for concision.

For example, the receiving unit can receive a first system switching instruction. According to an example of the present application, the receiving unit can receive the first system switching instruction input by the user as needed. Alternatively, according to another example of the present application, in case that the computer system is a portable computer, it is possible to set a first state for running the first operating system and a second state for running the second operating system for the portable computer in advance, and the first system switching instruction is automatically generated by the computer system when it is detected that the portable computer is transformed to the first state from the second state, and the second system switching instruction is received by the receiving unit. For example, when the portable computer is transformed from the state of a tablet computer which does not use the physical keyboard to the state wherein the physical keyboard is normally used (such as by rotating or turning over the screen), the first system switching instruction can be generated and received by the receiving unit.

The sleeping control unit can make the second operating system to sleep according to the first system switching instruction. Then, the pre-stored CPU state data of the first operating system can be restored by the CPU state restoring unit according to the first system switching instruction. As above, the CPU state data of the first operating system is stored according to the second system switching instruction in the case that the second system switching instruction is received during the running of the first operating system.

The system restoring unit can be configured to restore the first operating system through the memory image data of the first operating system and the CPU state data of the first operating system. The system running unit can also run the first operating system after the system restoring unit restored the first operating system.

As above, the second storage area is invisible to the first operating system without launching the system memory access drive. For example, when the first operating system is restored by the system restoring unit, the first operating system can be informed that the range of physical addresses of the system memory is the range of physical addresses of the first storage area, so that the first operating system can only access the system memory of the first storage area.

Through the control device of the embodiment, after the first operating system is switched to the second operating system quickly, it is also possible to switch back to the first operating system through the memory data maintained in the first storage area upon receiving the second operating system switching instruction and the CPU state data of the first operating system stored upon receiving the second operating system switching instruction, so that the time taken for the switching between operating systems will be significantly saved.

According to another example of the present application, when the first system switching instruction is received, the CPU state data of the second operating system is stored according to the first system switching instruction. As above, the CPU state data of the second operating system can be stored into the non-volatile memory such as ROM-BIOS. Besides, since the system memory does not power off, the system memory will maintain the memory data of the second operating system in the second storage area when receiving the first operating system switching instruction.

When the memory data of the second operating system is maintained in the second storage area and the second system switching instruction is received during the running of the first operating system, it is possible to restore and run the second operating system through the memory data of the second operating system and the CPU state data of the memory data of the second operating system by the system restoring unit without need to load the image data of the second operating system into the second storage area of the system memory.

According to another example of the present application, after switching from the second operating system to the first operating system, the receiving further receives a power-off instruction during the running of the first operating system. The image data storage unit can update the pre-stored memory image data of the second operating system according to the memory data of the second operating system maintained in the second storage area so that the second operating system can run in the updated state for the next operation.

Next, a computer system according to an embodiment of the present application is illustrated with reference to FIG. 6. FIG. 6 shows an exemplary structure block diagram of the computer according to an embodiment of the present application.

As shown in FIG. 6, the computer system 600 of the present embodiment can comprise a system memory 610, an image data storage unit 620, a Basic Input/Output System (BIOS) 630 and a processing unit 640. The units/modules of the computer system 600 can perform the steps/functions of the control method shown in FIG. 1. Thus, the detailed description is omitted for concision.

For example, the system memory 610 can comprise a first storage area and a second storage area. The image data storage unit 620 can comprise the storage device such as a hard disk to store the memory image data. The Basic Input/Output System (BIOS) 630 can comprises a system loading module 632. The system loading module 632 loads the first operating system into the first storage area. Specifically, the system loading module 632 can load the first operating system into the first storage area when the computer system starts up.

The processing unit 640 can comprises a system running module 642 and an image data loading module 644. The system running module 642 can run the first operating system. The image data loading module 644 comprises a system memory access drive. The image data loading module 644 can launch the system memory access drive by the first operating system to load the pre-stored memory image data into the second storage area in the system memory through the system memory access drive. The memory image data of the second operating system can be loaded by the image data loading module 644 immediately after the loading of the first operating system is completed and the first operating system starts to run. Alternatively, the memory image data of the second operating system can be loaded by the image data loading module 644 at any time after the first operating system starts to run.

According to an example of the present application, the second storage area is invisible to the first operating system without launching the system memory access drive. when the first operating system is loaded into the first storage area of the system memory by the system loading module 632, the system loading module 632 can inform the first operating system that the range of physical addresses of the system memory is the range of physical addresses of the first storage area, so that the first operating system can only access the system memory of the first storage area without launching the system memory access drive. The system memory access drive can be configured to operate the system memory of the specified addresses directly and bypass the default memory control mechanics of the system. For example, the range of physical addresses of the second storage area can be stored in the system memory access drive, so that when the system memory access drive determines that it is invoked by the first operating system, the system memory access drive can operate the second storage area by the system memory access drive. Alternatively, when it is invoked by the first operating system, the system memory access drive can acquire the range of physical addresses of the second storage area from BIOS. Thereby, by means of launching the system memory access drive by the first operating system, the pre-stored memory image data of the second operating system can be loaded into the second storage area in the system memory by the system memory access drive.

According to an example of the present application, it is possible to run the second operating system in advance, and during the running of the second operating system, the memory data used by the second operating system in the system memory at the current moment are acquired, and the memory data used by the second operating system in the system memory at the current moment acquired are stored in the image data storage unit 620 as the memory image data of the second operating system.

Through the computer system of the present embodiment, it is possible to load the memory image data of the second operating system during the running of the first operating system, so that the second operating system can be restored directly through the memory image data, thus the time taken for the switching of operating systems will be significantly saved. Besides, since the second operating system is restored through the memory image data, there is no need to perform the installation of the second operating system, and the normal booting process of the second operating system is omitted, thus the complexity relating to the installation and/or updating process of the second operating system is simplified.

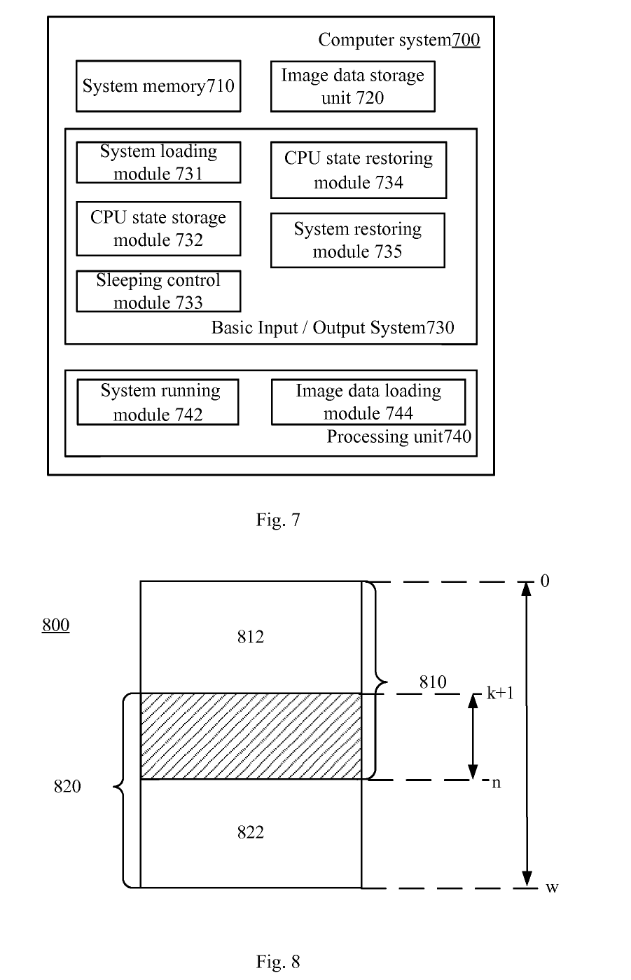

Next, a computer system according to another embodiment of the present application is illustrated with reference to FIG. 7. FIG. 7 shows an exemplary structure block diagram of the computer according to another embodiment of the present application. The units/modules of the computer system 700 can perform the steps/functions of the control method shown in FIG. 2. Thus, the detailed description is omitted for concision.

For example, the computer system 700 of the embodiment can comprise a system memory 710, an image data storage unit 720, a Basic Input/Output System (BIOS) 730 and a processing unit 740.

The system memory 710 can comprise a first storage area and a second storage area. The image data storage unit 720 can comprise the storage device such as a hard disk to store the memory image data. The Basic Input/Output System (BIOS) 730 can comprises a system loading module 731. The system loading module 731 loads the first operating system into the first storage area. Specifically, the system loading module 731 can load the first operating system into the first storage area when the computer system starts up.

The processing unit 740 can comprises a system running module 742 and an image data loading module 744. The system running module 742 can run the first operating system. The image data loading module 744 comprises a system memory access drive. The image data loading module 744 can launch the system memory access drive by the first operating system to load the pre-stored memory image data into the second storage area in the system memory through the system memory access drive. The memory image data of the second operating system can be loaded by the image data loading module 744 immediately after the loading of the first operating system is completed and the first operating system starts to run. Alternatively, the memory image data of the second operating system can be loaded by the image data loading module 744 at any time after the first operating system starts to run.

The computer system 700 further comprises a receiving unit 710. In the present embodiment, the Basic Input/Output System 730 further comprises a CPU state storage module 732, a sleeping control module 733, a CPU state restoring module 34 and a system restoring module 735. The CPU state storage module 732 can store the CPU state data. According to an example of the present application, it is possible to run the second operating system in advance, and during the running of the second operating system, the CPU state data at the current moment is also acquired at the time of acquiring the memory data used by the second operating system in the system memory and the CPU state data are stored into the CPU state storage module 732 so as to restore the pre-stored CPU state data of the second operating system. That is, in the embodiment, the pre-stored CPU state data of the second operating system in the CPU state storage module 732 and the pre-stored memory image data of the second operating system in the image data storage unit 720 are acquired at the same time.

The receiving unit 710 can receive a second system switching instruction. The sleeping control module 733 can make the first operating system to sleep according to the second system switching instruction. Then, the pre-stored CPU state data of the second operating system in the CPU state storage module can be restored by the CPU state restoring module 734 according to the second system switching instruction.

The system restoring module 735 can restore the second operating system through the memory image data of the second operating system and the CPU state data of the second operating system. In the embodiment, the system running module 742 can run the second operating system after the second operating system was restored.

According to another example of the present application, the first storage area in the system memory is invisible to the second operating system. For example, when the second operating system is restored by the system restoring module 735, the system restoring module 735 can inform the second operating system that the range of physical addresses of the system memory is the range of physical addresses of the second storage area, so that the second operating system can only access the system memory of the second storage area.

Through the computer system of the present embodiment, it is possible to load the memory image data of the second operating system during the running of the first operating system, and when a switching between two operating systems is performed, it is possible to restore the second operating system by loading the pre-stored memory image data of the second operating system and the pre-stored CPU state data of the second operating system so that the time taken for the switching of operating systems will be significantly saved. Besides, since the second operating system is restored through the memory image data, there is no need to perform the installation of the second operating system, and the normal booting process of the second operating system is omitted, thus the complexity relating to the installation and/or updating process of the second operating system is simplified.

Though in the present embodiment, the case that the CPU state restoring module 734 and the system restoring module 735 are included in the Basic Input/Output System is taken as an example for illustration, but the present application is not limited to this. According to an alternative embodiment, the CPU state restoring module 734 and/or the system restoring module 735 can also be included in the processing unit.

Next, FIG. 8 shows an exemplary explanatory diagram of the system memory of the computer according to an embodiment of the present application. FIG. 9 depicts a flowchart of the control method 900 according to an embodiment of the present application. In the following, a control method according to an embodiment of the present application is described with reference to FIG. 8 and FIG. 9.

As shown in FIG. 8, the system memory 800 of the computer comprises a first storage area 810 and a second storage area 820. The first storage area 810 comprises a first system storage portion 812 and a first shared data storage portion. The second storage area 820 comprises a second system storage portion 822 and a second shared data storage portion. The first shared data storage portion and the second shared data storage portion overlap each other (as shown in the shaded area in FIG. 8).

Specifically, in the example as shown in FIG. 8, the memory addresses range of the system memory 800 of the computer is 0-w. The memory addresses range of the first storage area 810 is 0-n, wherein the memory addresses range of the first system storage portion 812 included in the first storage area 810 is 0-k, and the memory addresses range of the first shared data storage portion is (k+1)-n. The memory addresses range of the second storage area 820 is (k+1)-w, wherein the memory addresses range of the second system storage portion 822 included in the second storage area 820 is (n+1)-w, and the memory addresses range of the second shared data storage portion is (k+1)-n. That is, the first shared data storage portion and the second shared data storage portion overlap each other, and the memory addresses range of them are both (k+1)-n.

The control method 900 shown in FIG. 9 can be applied in the computer as shown in FIG. 8. As shown in FIG. 9, in step S901, loading a first operating system into the system memory so that the user can operate the computer through the first operating system. Then, in step S902, storing a first shared data into the first shared data storage portion and storing a first system data of the first operating system into a first system storage portion by the first operating system. The first system data can comprise the system files needed during the running of the first operating system. The first shared data can comprise the useful data during the running of the first operating system and the second operating system. The first shared data can be the data generated when the first operating system is running. For example, when the user edits a file using the word processing application such as Word® under the first operating system and desires the file can be used and edited under the second operating system, the file can be stored into the first shared data storage portion as the first shared data.

According to an example of the present application, in step S901, the first operating system can be informed of the memory address ranges of the first system storage portion and the first shared data storage portion, and when the first operating system has been loaded into the system memory, the first operating system can be loaded into the first system storage portion so as to perform the data storage operation through the first operating system. For example, in the example as shown in FIG. 8, the first operating system can be informed of the memory address ranges of the first system storage portion 812 and the first shared data storage portion by BIOS when the system memory is initialized, and the first operating system is loaded into the first system storage portion 812 of the first storage area 810. At this time, the second storage area 820 can be set as invisible to the first operating system.

In step S902, during the running of the first operating system, when the first shared data exists, the first shared data can be stored into the first shared data storage portion according to the memory address range of the first shared data storage portion informed to the first operating system in step S901. In addition, the first system data of the first operating system can be stored into the first system storage portion according to the memory address range of the first system storage portion. As shown in the example in FIG. 8, the memory addresses range of the first shared data storage portion is (k+1)-n, and the first operating system can store the first shared data generated during the running thereof into the system memory with the address of (k+1)-n. On the other hand, the memory addresses range of the first system storage portion 812 is 0-k and the first operating system can store the first system data into the system memory with the address of 0-k.

Alternatively, in step S902, in response to the second system switching instruction, the first shared data can be stored into the first shared data storage portion and the first system data of the first operating system can be stored into the first system storage portion by the first operating system according to the memory address ranges of the first system storage portion and the first shared data storage portion. Specifically, the second system switching instruction can indicate to switch the computer from the first operating system to the second operating system. Before receiving the second system switching instruction, the first system data and the first shared data can both be stored into the first system storage portion by the first operating system, and after receiving the second system switching instruction, the first shared data can be transfer from the first system storage portion to the first shared data storage portion by the first operating system.

In addition, according to another example of the present application, in step S901, the first operating system can be loaded into the arbitrary location in the system memory. In step S902, when the first shared data is to be stored by the first operating system, the memory address range of the first shared data storage portion is inquired, and the first shared data storage portion is cleared according to the memory address range of the first shared data storage portion. Then, the first shared data is stored into the first shared data storage portion by the first operating system.

For example, in the example as shown in FIG. 8, the first operating system is informed that the memory address range of the system memory 800 is 0-w by BIOS when the system memory is initialized, that is, the system memory 800 is fully visible to the first operating system, and the first operating system can be loaded into the arbitrary location in the system memory 800. When the first shared data is to be stored by the first operating system, the first operating system will acquire that the memory addresses range of the first shared data storage portion is (k+1)-n, and the first operating system can clear the data currently stored in the system memory with the address of (k+1)-n (for example, by copying the data currently stored in the system memory with the address of (k+1)-n to the other storage area of the system memory), and store the first shared data generated during the running thereof into the system memory with the address of (k+1)-n.

In addition, in step S901, in the case that the first operating system is loading into the arbitrary location in the system memory 800, in step S902, in response to the second system switching instruction, the memory address range of the second system storage portion is inquired, and the data in the second system storage portion is cleared by the first operating system according to the memory address range of the second system storage portion. Then, the first system data of the first operating system is stored into the first system storage portion.

Next, in step S903, the second operating system is loaded into the second system storage portion according to the second system switching instruction. As above, the second system switching instruction can indicate to switch the computer from the first operating system to the second operating system. Specifically, after the first shared data was stored into the first shared data storage portion and the first system data of the first operating system was stored into the first system storage portion, a BIOS event can be triggered to awaken BIOS, and the second operating system is loaded into the second system storage portion by BIOS.

Last, in step S904, the first shared data is acquired from the second shared data storage portion by the second operating system, and the corresponding restoring operation is performed according to the first shared data. Specifically, the second operating system can be informed of the memory address ranges of the second system storage portion and the second shared data storage portion. The first shared data is acquired from the second shared data storage portion by the second operating system according to the memory address range of the second shared data storage portion. For example, in the example shown in FIG. 8, upon receiving the second system switching instruction, BIOS will inform the second operating system of the memory address range of the second system storage portion 822 included in the second storage area being (n+1)-w and the memory address range of the second shared data storage portion being (k+1)-n. Then, the second operating system is loaded into the system memory with the address of (n+1)-w, and the first shared data stored in the second shared data storage portion is acquired by the second operating system, and the corresponding restoring operation is performed according to the first shared data.

Furthermore, according to another embodiment of the present application, during the running of the second operation system, the control method 900 shown in FIG. 9 can further comprise storing the second shared data into the second shared data storage portion by the second operating system, and storing the second system data of the second operating system into the second system storage portion. Upon receiving the first system switching instruction indicating switching the computer from the second operating system to the first operating system, the first operating system can be started up by activating BIOS and invoking the first system data stored in the first system storage portion by BIOS. The second shared data is acquired from the first shared data storage portion by the first operating system, and the corresponding restoring operation is performed according to the second shared data.

According to the control method of the present embodiment, the computer is enabled to switch between two operating systems effectively to improve the utilization ratio of the system memory. In addition, by storing the data shared between the two operating systems into the overlapped portion of the two storage areas contained in the memory, even if a system switching has been performed, the shared data can be conveniently acquired in the switched operating system, so that the data synchronization between the two operating systems is achieved.

In addition, according to another embodiment of the present application, the computer can further comprise a memory. in the case that the size of the first shared data is larger than the first shared data storage portion, it is possible to store the first shared data into the memory, and save the storage address thereof in the memory in the first shared data storage portion, so that when switching to the second operating system, the second shared data storage portion can be accessed by the second operating system to acquire the first shared data stored in the memory.

Alternatively, in the case that the first operating has acquired the memory address range of the first shared data storage area, when the first shared data is larger than the first shared data storage portion, it is possible to inquire the memory address range of the second shared data storage area, and adjust the memory address ranges of the first, second shared data storage areas and the memory address range of the second system storage portion according to the size of the first shared data. Specifically, it is possible to reduce the memory address range of the second system storage area and increase the memory address ranges of the first shared data storage area and the second shared data storage area accordingly in accordance to the size of the first shared data, so that the first shared data is stored into the adjusted the first shared data storage area by the first operating system. The second operating system can be informed of the adjusted memory address ranges of the second system storage area and the second shared data storage area, so that the second operating system can be load correctly after the control right is switched from the first operating system to the second operating system, and the first shared data can be acquired from the adjusted the second shared data storage area by the second operating system to perform the restoring operation.

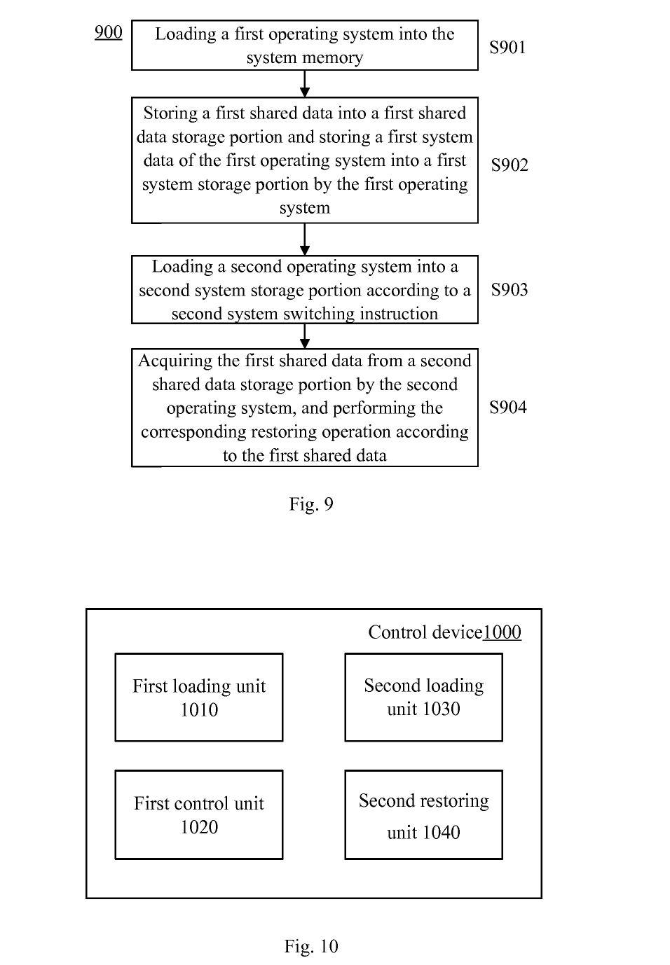

Next, the control device according to an embodiment of the present application is illustrated with reference to FIG. 10. FIG. 10 shows an exemplary structure block diagram of the control device 1000 according to an embodiment of the present application. In the embodiment, the control device 1000 can be applied in the computer with the system memory divided into two storage areas. Specifically, as shown in FIG. 8, the two storage areas of the system memory are a first storage area and a second storage area respectively. The first storage area comprises a first system storage portion and a first shared data storage portion. The second storage area comprises a second system storage portion and a second shared data storage portion. The first shared data storage portion and the second shared data storage portion overlap each other.

As shown in FIG. 10, the control device 1000 of the present embodiment can comprise a first loading unit 1010, a first control unit 1020, a second loading unit 1030, and a second restoring unit 1040. The units of the control device 1000 can perform the steps/functions of the control method shown in FIG. 9. Thus, the detailed description is omitted for concision.

For example, the first loading unit 1010 can load the first operating system into the first storage area so that the user can operate the computer through the first operating system. The first control unit 1020 can store a first shared data into the first shared data storage portion and store a first system data of the first operating system into a first system storage portion by the first operating system. As above, the first system data can comprise the system files needed during the running of the first operating system. The first shared data can comprise the useful data during the running of the first operating system and the second operating system. The first shared data can be the data generated when the first operating system is running. For example, when the user edits a file using the word processing application such as Word® under the first operating system and desires the file can be used and edited under the second operating system, the file can be stored into the first shared data storage portion as the first shared data.

According to an example of the present application, the first loading unit 1010 can inform the first operating system of the memory address ranges of the first system storage portion and the first shared data storage portion, and load the first operating system into the first system storage portion. During the running of the first operating system, the first control unit 1020 can store the first shared data into the first shared data storage portion by the first operating system according to the memory address ranges of the first system storage area and the first shared data storage portion informed by the first loading unit 1010, and store the first system data of the first operating system into the first system storage portion.

Alternatively, in response to the second system switching instruction, the first control unit 1020 can store the first shared data into the first shared data storage portion and the first system data of the first operating system into the first system storage portion by the first operating system according to the memory address ranges of the first system storage portion and the first shared data storage portion. Specifically, the second system switching instruction can indicate to switch the computer from the first operating system to the second operating system. Before receiving the second system switching instruction, the first control unit 1020 can store the first system data and the first shared data into the first system storage portion by the first operating system, and after receiving the second system switching instruction, the first control unit 1020 can transfer the first shared data from the first system storage portion to the first shared data storage portion by the first operating system.

In addition, according to another example of the present application, the first loading unit 1010 can load the first operating system into the arbitrary location in the system memory. The first control unit 1020 can comprise an inquiring module, a clearing module, and a control storage module. Specifically, when the first shared data is to be stored by the first operating system, the inquiring module inquires the memory address range of the first shared data storage portion. The clearing module clear the first shared data storage portion according to the memory address range of the first shared data storage portion inquired by the inquiring module. After clearing the first shared data storage portion, the control storage module can store the first shared data into the first shared data storage portion by the first operating system according to the memory address range of the first shared data storage portion inquired by the inquiring module.

For example, in the example as shown in FIG. 8, the first loading unit 1010 informs the first operating system that the memory address range of the system memory 800 is 0-w, that is, the system memory 800 is fully visible to the first operating system, and the first operating system can be loaded into the system memory 800. When the first shared data is to be stored by the first operating system, the inquiring module inquires and acquires that the memory addresses range of the first shared data storage portion is (k+1)-n. The clearing module can clear the data currently stored in the system memory with the address of (k+1)-n (for example, by copying the data currently stored in the system memory with the address of (k+1)-n to the other storage area of the system memory). The clearing module can store the first shared data generated during the running thereof into the system memory with the address of (k+1)-n.

In addition, in the case that the first operating system is loaded into the arbitrary location in the system memory 800 by the first loading unit 1010, in response to the second system switching instruction, the inquiring module inquires the memory address range of the second system storage portion. The clearing module clears the data in the second system storage portion by the first operating system according to the memory address range of the second system storage portion. Then, the control module stores the first system data of the first operating system into the first system storage portion according to the memory address range of the second system storage portion inquired by the inquiring module.

The second operating system is loaded into the second system storage portion by the second loading unit 1030 according to the second system switching instruction. As above, the second system switching instruction can indicate to switch the computer from the first operating system to the second operating system. The second restoring unit 1040 can acquire the first shared data from the second shared data storage portion by the second operating system, and the corresponding restoring operation is performed according to the first shared data.

According to the control method of the present embodiment, the computer is enabled to switch between two operating systems effectively to improve the utilization ratio of the system memory. In addition, by storing the data shared between the two operating systems into the overlapped portion of the two storage areas contained in the memory, even if a system switching has been performed, the shared data can be conveniently acquired in the switched operating system, so that the data synchronization between the two operating systems is achieved.

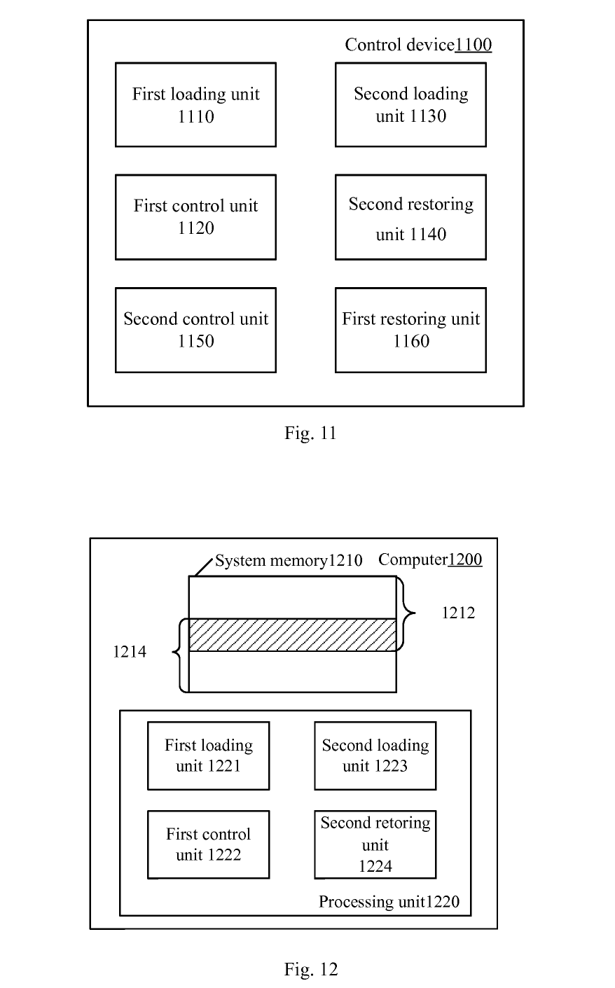

Next, the control device according to another embodiment of the present application is illustrated with reference to FIG. 11. FIG. 11 shows an exemplary structure block diagram of the control device 1100 according to an embodiment of the present application. In the embodiment, the control device 1000 can be applied in the computer with the system memory divided into two storage areas. Specifically, as shown in FIG. 8, the two storage areas of the system memory are a first storage area and a second storage area respectively. The first storage area comprises a first system storage portion and a first shared data storage portion. The second storage area comprises a second system storage portion and a second shared data storage portion. The first shared data storage portion and the second shared data storage portion overlap each other.

Similar to the control device 1000 shown in FIG. 10, in FIG. 11, the control device 1100 can comprise a first loading unit 1110, a first control unit 1120, a second loading unit 1130, and a second restoring unit 1140. The first loading unit 1110 can load the first operating system into the system memory so that the user can operate the computer through the first operating system. The first control unit 1020 can store a first shared data into the first shared data storage portion and store a first system data of the first operating system into a first system storage portion by the first operating system.

The control device 1100 of the present embodiment further comprises a second control unit 1150 and a first restoring unit 1160. Specifically, during the running of the second operating system, the second control unit 1150 can store the second shared data into the second shared data storage portion by the second operating system, and store the second system data of the second operating system into the second system storage portion. In the present embodiment, the first loading unit 1110 can run the first system data stored in the first system storage portion to start up the first operating system according to the first system switching instruction. The first system switching instruction can indicate to switch the computer from the second operating system into the first operating system. The first restoring unit 1160 can acquire the second shared data from the first shared data storage portion by the first operating system, and perform the corresponding restoring operation according to the second shared data.

According to the control method of the present embodiment, the computer is enabled to switch between two operating systems effectively to improve the utilization ratio of the system memory. In addition, by storing the data shared between the two operating systems into the overlapped portion of the two storage areas contained in the memory, even if a system switching has been performed, the shared data can be conveniently acquired in the switched operating system, so that the data synchronization between the two operating systems is achieved.

In addition, according to another embodiment of the present application, the computer can further comprise a memory. in the case that the size of the first shared data is larger than the first shared data storage portion, it is possible to store the first shared data into the memory, and save the storage address thereof in the memory in the first shared data storage portion, so that when switching to the second operating system, the second shared data storage portion can be accessed by the second operating system to acquire the first shared data stored in the memory.

Alternatively, in the case that the first operating has acquired the memory address range of the first shared data storage area, when the first shared data is larger than the first shared data storage portion, it is possible to inquire the memory address range of the second shared data storage area, and adjust the memory address ranges of the first, second shared data storage areas and the memory address range of the second system storage portion according to the size of the first shared data. Specifically, it is possible to reduce the memory address range of the second system storage area and increase the memory address ranges of the first shared data storage area and the second shared data storage area accordingly in accordance to the size of the first shared data, so that the first shared data is stored into the adjusted the first shared data storage area by the first operating system. The second operating system can be informed of the adjusted memory address ranges of the second system storage area and the second shared data storage area, so that the second operating system can be load correctly after the control right is switched from the first operating system to the second operating system, and the first shared data can be acquired from the adjusted the second shared data storage area by the second operating system to perform the restoring operation.

Next, a computer system according to an embodiment of the present application is illustrated with reference to FIG. 12. FIG. 12 shows an exemplary structure block diagram of the computer 1200 according to an embodiment of the present application. As shown in FIG. 12, the computer system 1200 of the present embodiment can comprise a system memory 1210 and a processing unit 1220. The system memory 1210 can comprise a first storage area 1212 and a second storage area 1214. The first storage area comprises a first system storage portion and a first shared data storage portion (as shown in the non-shaded portion in the first storage area 1212). The second storage area comprises a second system storage portion and a second shared data storage portion (as shown in the non-shaded portion in the second storage area 1214). The first shared data storage portion and the second shared data storage portion overlap each other (as shown in the shaded portion). The processing unit 1220 can comprise a first loading module 1221, a first control module 1222, a second loading module 1223, and a second restoring module 1224. The units of the computer 1200 can perform the steps/functions of the control method shown in FIG. 9. Thus, the detailed description is omitted for concision.

For example, the first loading module 1221 can load the first operating system into the first storage area. The first control module 1222 can store a first shared data into the first shared data storage portion and store a first system data of the first operating system into a first system storage portion by the first operating system. The second operating system is loaded into the second system storage portion by the second loading module 1223 according to the second system switching instruction. The second restoring module 1224 can acquire the first shared data from the second shared data storage portion by the second operating system, and the corresponding restoring operation is performed according to the first shared data.

According to the computer of the present embodiment, the computer is enabled to switch between two operating systems effectively to improve the utilization ratio of the system memory. In addition, by storing the data shared between the two operating systems into the overlapped portion of the two storage areas contained in the memory, even if a system switching has been performed, the shared data can be conveniently acquired in the switched operating system, so that the data synchronization between the two operating systems is achieved.

Through the above description of the embodiments, the skilled in the art can clearly understand that the present invention is achieved through software and a necessary hardware platform, of course, can be implemented entirely by hardware. Based on such understanding, the technical solution of the present invention, the background art to contribute to all or a portion may be embodied in the form of a software product, the computer software product may be stored in a storage medium, such as a ROM/RAM, disk, optical disk, etc., comprises a plurality of instructions for a method that allows a computer device (may be a personal computer, server, or network equipment, etc.) to perform various embodiments of the present invention or some portion of the embodiment.

In the embodiment of the invention, the unit/module can be implemented in software for execution by various types of processors. For example, an identification module of executable code may include one or more physical or logical blocks of computer instructions, for example, which can be constructed as an object, procedure, or function. Nevertheless, the identified module of executable code without physically located together, but may include different instructions stored in different bit on, when these instructions are logically combined together, and its constituent units/modules and achieve the unit/modules specified purposes.

Unit/module can be implemented using software, taking into account the level of the existing hardware technology, it can be implemented in software, the unit/module, in the case of not considering the cost of skilled in the art can build the corresponding hardware circuit to achieve the function corresponding to the hardware circuit comprises a conventional ultra-large scale integrated (VLSI) circuit or a gate array, such as logic chips, existing semiconductor of the transistor and the like, or other discrete components. The module may further with the programmable hardware device, such as a field programmable gate array, programmable array logic, programmable logic devices, etc. to achieve.

It should be understood by those skilled in the art that various modifications, combinations, sub-combinations and alterations may occur depending on design requirements and other factors insofar as they are within the scope of the appended claims or the equivalents thereof

What is claimed is:

1. A control method applied in a computer system, the computer system including a system memory which is divided into two storage areas, the two storage areas having a first storage area and a second storage area, comprising:
loading a first operating system into the first storage area;
running the first operating system; and
launching a system memory access drive by the first operating system for loading the pre-stored memory image data of a second operating system into the second storage area by the system memory access drive.

2. The control method of claim 1, wherein
the second storage area is invisible to the first operating system without launching the system memory access drive.

3. The control method of claim 1, further comprising:
receiving a second system switching instruction;
making the first operating system to sleep according to the second system switching instruction;
restoring the pre-stored CPU state data of the second operating system according to the second system switching instruction;
restoring the second operating system through the memory image data of the second operating system and the CPU state data of the second operating system; and
running the second operating system.

4. The control method of claim 3, wherein
the first storage area is invisible to the second operating system.

5. The control method of claim 3, further comprise:
the CPU state data of the first operating system is stored of the second system switching instruction so as to maintain the memory data of the first operating system in the first storage area.

6. The control method of claim 5, further comprising:
receiving a first system switching instruction;
making the second operating system to sleep of the first system switching instruction;
restoring the pre-stored CPU state data of the first operating system of the first system switching instruction; and
restoring and running the first operating system through the memory image data of the first operating system and the CPU state data of the first operating system.

7. The control method of claim 5, further comprising:
storing the CPU state data of the second operating system of the first system switching instruction; and
maintaining the memory data of the second operating system in the second storage area.

8. The control method of claim 7, further comprising:
when the memory data of the second operating system is maintained in the second storage area and the second system switching instruction is received during the running of the first operating system, restoring and running the second operating system through the memory data of the second operating system and the CPU state data of the memory data of the second operating system.

9. The control method of claim 5, further comprising:
receiving a power-off instruction during the running of the first operating system;
updating the pre-stored memory image data of the second operating system according to the memory data of the second operating system maintained in the second storage area.

10. A control device applied in a computer system, wherein the computer system includes a system memory which is divided into two storage areas, the two storage areas being a first storage area and a second storage area, the control device comprise:
a system loading unit configured to load a first operating system into the first storage area;
a system running unit configured to run the first operating system;
a image data loading unit having a system memory access drive configured to launch the system memory access drive by the first operating system so as to load the pre-stored memory image data of a second operating system into the second storage area through the system memory access drive.

11. The control device of claim 10, wherein
the second storage area is invisible to the first operating system without launching the system memory access drive.

12. The control device of claim 10, further comprising:
a receiving unit configured to receive a second system switching instruction;
a sleeping control unit configured to make the first operating system to sleep according to the second system switching instruction;
a CPU state restoring unit configured to restore the pre-stored CPU state data of the second operating system according to the second system switching instruction;
a system restoring unit configured to restore the second operating system through the memory image data of the second operating system and the CPU state data of the second operating system; and
the system running unit is further configured to run the second operating system.

13. The control device of claim 12, wherein
the first storage area is invisible to the second operating system.

14. The control device of claim 12, further comprise:
a CPU state storage unit configured to store the CPU state data of the first operating system according to the second system switching instruction;
wherein the system memory maintains the memory data of the first operating system in the first storage area.

15. The control device of claim 14, wherein
the receiving unit is further configured to receive a first system switching instruction;
the sleeping control unit is further configured to make the second operating system to sleep according to the first system switching instruction; and
the CPU state restoring unit is further configured to restore the pre-stored CPU state data of the first operating system according to the first system switching instruction;
the system restoring unit is further configured to restore first operating system through the memory image data of the first operating system and the CPU state data of the first operating system; and
the system running unit is further configured to run the first operating system after the first operating system is restored by the system restoring unit.

16. The control device of claim 15, wherein:
the CPU state storage unit is further configured to store the CPU state data of the second operating system according to the first system switching instruction; and
the system memory further maintains the memory data of the second operating system in the second storage area.

17. The control device of claim 16, further comprising:
when the memory data of the second operating system is maintained in the second storage area and the second system switching instruction is received during the running of the first operating system, the system restoring unit is further configured to restore the second operating system through the memory data of the second operating system and the CPU state data of the memory data of the second operating system.

18. The control device of claim 15, wherein:
the receiving unit is further configured to receive a power-off instruction during the running of the first operating system;
the control device further comprising:
an image data storage unit configured to update the pre-stored memory image data of the second operating system according to the memory data of the second operating system maintained in the second storage area.

19. A computer system, comprising:
a system memory having a first storage area and a second storage area;
an image data storage unit configured to store the memory image data;
a Basic Input/Output System including
a system loading module configured to load the first operating system into the first storage area; and
a processing unit including
a system running module configured to run the first operating system, and
an image data loading module having a system memory access drive configured to launch the system memory access drive by the first operating system so as to load the pre-stored memory image data of a second operating system into the second storage area through the system memory access drive.

20. The computer system of claim 19, further comprising:
a receiving unit configured to receive a second system switching instruction,
the Basic Input/Output System further comprises:
a CPU state storage unit configured to store the CPU state data;
a sleeping control unit configured to make the first operating system to sleep according to the second system switching instruction;
a CPU state restoring unit configured to restore the pre-stored CPU state data of the second operating system according to the second system switching instruction;
a system restoring unit configured to restore the second operating system through the memory image data of the second operating system and the CPU state data of the second operating system,
the system running unit is further configured to run the second operating system.

21. A control method applied in a computer, wherein the computer comprises a system memory which is divided into two storage areas, the two storage areas are a first storage area and a second storage area, the first storage area includes a first system storage portion and a first shared data storage portion, the second storage area includes a second system storage portion and a second shared data storage portion, and the first shared data storage portion and the second shared data storage portion overlap each other, the control method comprise:
loading a first operating system into the system memory;
storing a first shared data into a first shared data storage portion and storing a first system data of the first operating system into a first system storage portion by the first operating system;
loading a second operating system into a second system storage portion according to a second system switching instruction; and
acquiring the first shared data from a second shared data storage portion by the second operating system, and performing the corresponding restoring operation according to the first shared data.

22. The control method of claim 21, wherein said loading the first operating system into the system memory comprises:
informing the first operating system of the memory address ranges of the first system storage portion and the first shared data storage portion, and
loading the first operating system into the first system storage portion.

23. The control method of claim 22, wherein said storing the first shared data into the first shared data storage portion and storing the first system data of the first operating system into the first system storage portion by the first operating system comprises:
according to the second system switching instruction, storing the first shared data into the first shared data storage portion by the first operating system and storing the first system data of the first operating system into the first system storage portion in accordance with the memory address ranges of the first system storage portion and the first shared data storage portion.

24. The control method of claim 22, wherein said storing the first shared data into the first shared data storage portion and storing the first system data of the first operating system into the first system storage portion by the first operating system comprises:
during the running of the first operating system, storing the first shared data into the first shared data storage portion and storing the first system data of the first operating system into the first system storage portion by the first operating system in accordance with the memory address ranges of the first system storage portion and the first shared data storage portion.

25. The control method of claim 21, wherein said storing the first shared data into the first shared data storage portion by the first operating system comprises:
when the first shared data is to be stored by the first operating system, inquiring the memory address range of the first shared data storage portion;
clearing the first shared data storage portion according to the memory address range of the first shared data storage portion; and
storing the first shared data into the first shared data storage portion by the first operating system.

26. The control method of claim 25, wherein said storing the first system data of the first operating system into the first system storage portion comprises:
according to the second system switching instruction, inquiring the memory address range of the second system storage portion;
clearing the data in the second system storage portion by the first operating system according to the memory address range of the second system storage portion; and
storing the first system data of the first operating system into the first system storage portion.

27. The control method of claim 25, further comprising:
acquiring the memory address range of the second system storage portion when size of the first shared data is larger than the first shared data storage portion;
reducing the memory address range of the second system storage area and increasing the memory address ranges of the first shared data storage area and the second shared data storage area accordingly in accordance to the size of the first shared data;
storing the first shared data into the adjusted first shared data storage area by the first operating system; and
informing the second operating system of the adjusted memory address ranges of the second system storage area and the second shared data storage area.

28. The control method of claim 21, further comprising:
storing the second shared data into the second shared data storage portion by the second operating system, and storing the second system data of the second operating system into the second system storage portion;
according to the first system switching instruction, invoking the first system data stored in the first system storage portion to start up the first operating system; and
acquiring the second shared data from the first shared data storage portion by the first operating system, and performing the corresponding restoring operation according to the second shared data.

29. The control method of claim 21, wherein the computer further comprises a memory, the control method further comprising:
when the size of the first shared data is larger than the first shared data storage portion, storing the first shared data into the memory, and saving the storage address thereof in the memory in the first shared data storage portion.

30. A control device applied in a computer, wherein the computer comprises a system memory which is divided into two storage areas, the two storage areas are a first storage area and a second storage area, the first storage area includes a first system storage portion and a first shared data storage portion, the second storage area includes a second system storage portion and a second shared data storage portion, and the first shared data storage portion and the second shared data storage portion overlap each other, the control device comprise:
a first loading unit configured to load a first operating system into the system memory;
a first control unit configured to store a first shared data into the first shared data storage portion and store a first system data of the first operating system into the first system storage portion by the first operating system;
a second loading unit configured to load a second operating system into the second system storage portion according to a second system switching instruction; and
a second restoring unit configured to acquire the first shared data from a second shared data storage portion by the second operating system, and perform the corresponding restoring operation according to the first shared data.

31. The control device of claim 30, wherein
the first loading unit informs the first operating system of the memory address ranges of the first system storage portion and the first shared data storage portion, and loads the first operating system into the first system storage portion.

32. The control device of claim 31, wherein
according to the second system switching instruction, the first control unit stores the first shared data into the first shared data storage portion by the first operating system and stores the first system data of the first operating system into the first system storage portion in accordance with the memory address ranges of the first system storage portion and the first shared data storage portion.

33. The control device of claim 31, wherein
during the running of the first operating system, the first control unit stored the first shared data into the first shared data storage portion by the first operating system and stores the first system data of the first operating system into the first system storage portion in accordance with the memory address ranges of the first system storage portion and the first shared data storage portion.

34. The control device of claim 30, wherein the first control unit comprise:
an inquiring module configured to when the first shared data is to be stored by the first operating system, inquire the memory address range of the first shared data storage portion;
a clearing module configured to clear the first shared data storage portion according to the memory address range of the first shared data storage portion; and
a control storing module configured to store the first shared data into the first shared data storage portion by the first operating system.

35. The control device of claim 34, wherein
the inquiring module is further configured to inquire the memory address range of the second system storage portion according to the second system switching instruction;
the clearing module is further configured to clear the data in the second system storage portion by the first operating system according to the memory address range of the second system storage portion; and
the control storing module is further configured to store the first system data of the first operating system into the first system storage portion.

36. The control device of claim 30, further comprising:
a second control unit configured to store the second shared data into the second shared data storage portion by the second operating system, and store the second system data of the second operating system into the second system storage portion;
the first loading unit is further configured to according to the first system switching instruction, invoke the first system data stored in the first system storage portion to start up the first operating system; and
the control device further comprises:
a first restoring unit configured to acquire the second shared data from the first shared data storage portion by the first operating system, and perform the corresponding restoring operation of the second shared data.

37. A computer, comprising:
a system memory includes
a first storage area having a first system storage portion and a first shared data storage portion,
a second storage area having a second system storage portion and a second shared data storage portion,
wherein the first shared data storage portion and the second shared data storage portion overlap each other;
a processing unit includes
a first loading unit configured to load a first operating system into the system memory;
a first control unit configured to store a first shared data into the first shared data storage portion and store a first system data of the first operating system into the first system storage portion by the first operating system;
a second loading unit configured to load a second operating system into the second system storage portion according to a second system switching instruction; and
a second restoring unit configured to acquire the first shared data from a second shared data storage portion by the second operating system, and perform the corresponding restoring operation according to the first shared data.
